(19) United States
(12) Patent Application Publication
(10) Pub. No.: US 2007/0296167 A1
(43) Pub. Date: Dec. 27, 2007

(54) Road and sand sled

(76) Inventors: Herbert Beswick, Garfield, NJ (US); Mary Brizzi, Garfield, NJ (US)

Correspondence Address: Galasso & Associates, LP, P.O. Box 26503, Austin, TX, 78755-0503, US

(21) Appl. No.: 11/474,035

(22) Filed: Jun. 23, 2006

(51) Int. Cl. B62B 13/18

(52) U.S. Cl. 280/47.34; 280/8; 280/79.11

(57) ABSTRACT

Road and Sand Sled is a board with a raised front end, pull rope holes and rails secured by slide bolts. It also has four wheels with bearings that are attached to the axels with pressure caps. In order to use Road and Sand Sled, a user simply loads all of his or her supplies onto the sled. The rails can be folded upright and secured with the slide bolts, if the user needs to provide additional constraints for pulling a load. The sled is then dragged behind a user to a destination, using a rope inserted through the pull rope holes.

### CROSS REFERENCE TO RELATED APPLICATIONS

This Non-Provisional patent application does not claim priority to any United States provisional application or any foreign patent applications.

### FIELD OF THE DISCLOSURE

The disclosures made herein relate generally to the camping and outdoors industry. The invention discussed herein is in the general classification of outdoor accessory devices.

### BACKGROUND

Many people engage in a variety of outdoor activities for recreation and exercise. Backyards, parks and beaches are just some of the settings in which people relax and enjoy the outdoors. When people go to a beach for short or long visits, it is necessary to bring certain supplies. Some of the items regularly taken to the beach include: chairs, towels, an umbrella, sun-block, snacks, drinks and coolers. When children also attend, land toys such as shovels and buckets and water toys such as inner tubes, rafts and boogey boards must also be brought.

Taking all of these items to the beach can be difficult, especially when one must trek over hot sand. Currently, all of the items must be transported separately or in coolers and bags that must be carried by multiple persons.

Hence, there is a need in the art for an easy to use, effective and inexpensive device that will allow a single user to drag, rather than carry, all of the necessary items to an outdoor outing on the beach or elsewhere.

### SUMMARY OF THE DISCLOSURE

Road and Sand Sled consists of at least some of the following: a board with a raised front end having pull rope holes and rails secured by slide bolts along the perimeter of the board with wheels attached to the board.

The principal object of this invention is to provide a device for easily transporting a number of items to a beach or other outing.

Another object of this invention is to provide an affordable device for transporting items to an outing.

Another object of this invention is to provide an easy to use device that allows a single individual to move a large number of items to a beach without having to make several trips.

Yet another object of this invention is to provide a device that allows an individual to transport a number of items to an outdoor activity without having to carry the items.

### BRIEF DESCRIPTION OF THE DRAWINGS

FIG. 1 depicts a perspective view of the preferred embodiment of the invention.

FIG. 2 depicts a cross-sectional view of the preferred embodiment of the invention cut along the Line A-A of FIG. 1.

### DETAILED DESCRIPTION OF THE DRAWINGS

The preferred embodiment of Road and Sand Sled is comprised of at least some of the following: a board with a raised front end, pull rope holes and rails secured by slide bolts. It will also have four wheels with bearings that are attached to the axels with pressure caps

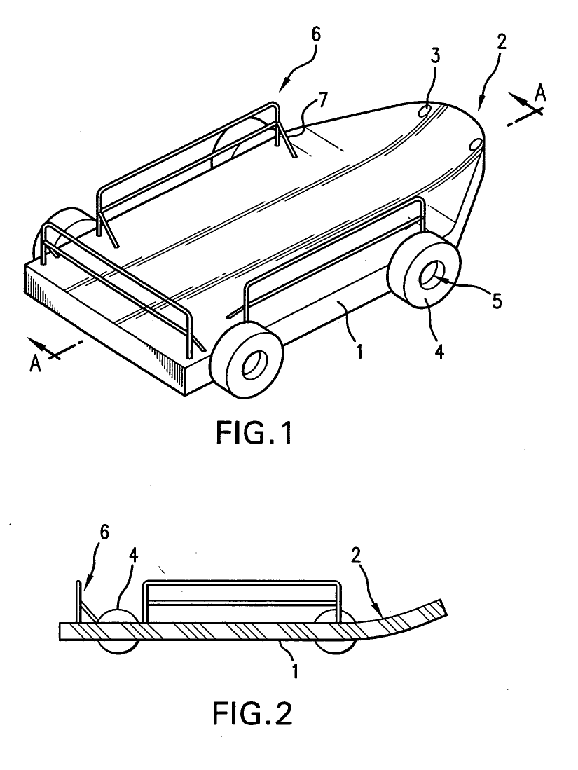

In the preferred embodiment of the invention, shown in FIG. 1, a board 1 has an elevated front 2 that is angled about fifteen degrees from the board 1. The board is made of plastic and is relatively flat and rectangular, however, the elevated front 2 has rounded edges. The top of the elevated front 2 has two holes 3 through it for a rope to be inserted. The holes are spaced approximately five inches apart. Four wheels 4 with bearings (not pictured) are located on the corners of the board 1. In the preferred embodiment, the wheels are made of plastic and secured to the axel by means of pressure caps 5. Rails 6 on the sides and back of the board 1 are hinged to the inside top of the board 1 and held upright by slide bolts 7. The rails 6 and the slide bolts 7 are made of metal.

FIG. 2 depicts a cross-sectional view of the preferred embodiment of the invention cut along the Line A-A of FIG. 1. The fifteen-degree angle of the elevated front 2 in relation to the board 1 can be seen in detail. Two of the wheels 4 and two of the rails 6 can also be seen from this view.

In order to use Road and Sand Sled, a user simply loads all of his supplies onto the board. The rails can be folded upright and secured with the slide bolts, if desired. The sled is then dragged behind a user to the destination.

The components of Road and Sand Sled may vary widely but will likely include plastic, metal and other components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Road and Sand Sled can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the board and other components of the present invention can be of various shapes and sizes. The preferred embodiment of the board is approximately fifty inches in length, thirty inches in width and four inches in thickness. The preferred embodiment of this invention has wheels with six-inch diameters. The rails are approximately six inches in height and extend approximately the length of the back and sides of the board.

It should also be obvious that the components of the invention can be made of various types of plastics or other suitable materials and can be of any color. For example, the board and wheels could be made of metal instead of plastic and the rails could be made of plastic instead of metal. While the current invention is discussed with regard to its usefulness on beaches, it should be obvious that the Road and Sand Sled could be utilized in any setting, indoor or outdoors.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A transport device comprising:
(a) a board with an elevated front; and
(b) a set of wheels attached to the board;

2. The transport device of claim 1 wherein the elevated front is angled approximately fifteen degrees from the board.

3. The transport device of claim 1 wherein the board is approximately rectangular.

4. The transport device of claim 1 wherein the board is made of plastic.

5. The transport device of claim 1 wherein the elevated front has rounded edges.

6. The transport device of claim 1 wherein the elevated front has two holes.

7. The transport device of claim 6 wherein a rope is inserted through the two holes.

8. The transport device of claim 1 wherein the set of wheels is attached to a set of bearings and located on the corners of the board.

9. The transport device of claim 1 wherein the set of wheels is made of plastic.

10. The transport device of claim 1 wherein the set of wheels is attached to at least one axel by a set of pressure caps.

11. The transport device of claim 1 further comprising
a back rail, a first side rail and a second side rail that are hinged to the inside top of the board and held upright by a set of slide bolts.

12. The transport device of claim 11 wherein the back rail, the first side rail, and the second side rail are made of metal.

13. A transport device comprising:
(a) an approximately rectangular board made of plastic with an elevated front angled at approximately fifteen degrees to the rectangular board;
(b) a first wheel, a second wheel, a third wheel, and a fourth wheel made of plastic and located on the four corners of the approximately rectangular board;
(c) a set of two holes located on the elevated front wherein the elevated front has rounded edges;
(d) a first axel connected to the first wheel and the second wheel and a second axel connected to the third wheel and the fourth wheel wherein the first wheel, the second wheel, the third wheel, and the fourth wheel are secured to the first axel and the second axel via a set of pressure caps; and
(e) a back rail, a first side rail and a second side rail made of metal that are hinged to the inside top of the board and held upright by a set of slide bolts.
